(19) United States
(12) Patent Application Publication
(10) Pub. No.: US 2022/0138536 A1
(43) Pub. Date: May 5, 2022

(54) ACTIONAL-STRUCTURAL SELF-ATTENTION GRAPH CONVOLUTIONAL NETWORK FOR ACTION RECOGNITION

(71) Applicant: Hong Kong Applied Science and Technology Research Institute Co., Ltd., Shatin (HK)

(72) Inventors: Hailiang LI, Tai Po (HK); Yang LIU, Kowloon (HK); Man Tik LI, Shenzhen (CN); Zhibin LEI, Kornhill (HK)

(73) Assignee: Hong Kong Applied Science and Technology Research Institute Co., Ltd, Shatin (HK)

(21) Appl. No.: 17/083,738

(22) Filed: Oct. 29, 2020

(51) Int. Cl. G06N 3/04; G06N 3/08

(52) U.S. Cl. CPC G06N 3/0472; G06N 3/0454; G06N 3/082

(57) ABSTRACT

The present disclosure describes methods, devices, and non-transitory computer readable storage medium for recognizing a human action using a graph convolutional network (GCN). The method includes obtaining, by a device, a plurality of joint poses. The device includes a memory storing instructions and a processor in communication with the memory. The method also includes normalizing, by the device, the plurality of joint poses to obtained a plurality of normalized joint poses; extracting, by the device, a plurality of rough features using a modified spatial-temporal GCN (ST-GCN) from the plurality of normalized joint poses; reducing, by the device, a feature dimension of the plurality of rough features to obtain a plurality of dimension-shrunk features; refining, by the device, the plurality of dimension-shrunk features based on a self-attention model to obtain a plurality of refined features; and recognizing, by the device, a human action based on the plurality of refined features.

### FIELD OF THE TECHNOLOGY

The present disclosure relates to a graph convolutional network (GCN) for human action recognition, and is particularly directed to a modified spatial-temporal GCN with a self-attention model.

### BACKGROUND OF THE DISCLOSURE

Human action recognition underwent active development in recent years, as it plays a significant role in video understanding. In general, human action can be recognized from multiple modalities, such as appearance, depth, optical flows, and body. Among these modalities, dynamic human skeletons usually convey significant information that is complementary to others. However, conventional approaches for modeling skeletons usually rely on hand-crafted parts or traversal rules, thus resulting in limited expressive power and difficulties for generalization and/or application.

There were many issues and problems associated with existing approaches for recognizing human actions by modeling skeletons, for example but not limited to, low recognition efficiency, slow recognition speed, and/or low recognition accuracy.

The present disclosure describes methods, devices, systems, and storage medium for recognizing a human action using an actional-structural self-attention graph convolutional network (GCN), which may overcome some of the challenges and drawbacks discussed above, improving overall performance, increasing recognition speed without sacrificing recognition accuracy.

### SUMMARY OF THE INVENTION

Embodiments of the present disclosure include methods, devices, and computer readable medium for an actional-structural self-attention graph convolutional network (GCN) system for recognizing one or more action.

The present disclosure describes a method for recognizing a human action using a graph convolutional network (GCN). The method includes obtaining, by a device, a plurality of joint poses. The device includes a memory storing instructions and a processor in communication with the memory. The method also includes normalizing, by the device, the plurality of joint poses to obtained a plurality of normalized joint poses; extracting, by the device, a plurality of rough features using a modified spatial-temporal GCN (ST-GCN) from the plurality of normalized joint poses; reducing, by the device, a feature dimension of the plurality of rough features to obtain a plurality of dimension-shrunk features; refining, by the device, the plurality of dimension-shrunk features based on a self-attention model to obtain a plurality of refined features; and recognizing, by the device, a human action based on the plurality of refined features.

The present disclosure describes a device for recognizing a human action using a graph convolutional network (GCN). The device includes a memory storing instructions; and a processor in communication with the memory. When the processor executes the instructions, the processor is configured to cause the device to obtain a plurality of joint poses; normalize the plurality of joint poses to obtained a plurality of normalized joint poses; extract a plurality of rough features using a modified spatial-temporal GCN (ST-GCN) from the plurality of normalized joint poses; reduce a feature dimension of the plurality of rough features to obtain a plurality of dimension-shrunk features; refine the plurality of dimension-shrunk features based on a self-attention model to obtain a plurality of refined features; and recognize a human action based on the plurality of refined features.

The present disclosure describes a non-transitory computer readable storage medium storing instructions. The instructions, when executed by a processor, cause the processor to perform obtaining a plurality of joint poses; normalizing the plurality of joint poses to obtained a plurality of normalized joint poses; extracting a plurality of rough features using a modified spatial-temporal GCN (ST-GCN) from the plurality of normalized joint poses; reducing a feature dimension of the plurality of rough features to obtain a plurality of dimension-shrunk features; refining the plurality of dimension-shrunk features based on a self-attention model to obtain a plurality of refined features; and recognizing a human action based on the plurality of refined features.

The above and other aspects and their implementations are described in greater details in the drawings, the descriptions, and the claims.

### BRIEF DESCRIPTION OF THE DRAWINGS

The system and method described below may be better understood with reference to the following drawings and description of non-limiting and non-exhaustive embodiments. The components in the drawings are not necessarily to scale. Emphasis instead is placed upon illustrating the principles of the disclosure.

FIG. 1 shows an exemplary electronic communication environment for implementing an actional-structural self-attention graph convolutional network (GCN) system for recognizing one or more action.

FIG. 2 shows electronic devices that may be used to implement various components of the electronic communication environment of FIG. 1.

FIG. 3A shows a schematic diagram of embodiments for recognizing one or more action by an actional-structural self-attention GCN.

FIG. 3B shows a work flow of embodiments for recognizing one or more action by a spatial-temporal GCN (ST-GCN).

FIG. 4 shows a flow diagram of embodiments for recognizing one or more action by an actional-structural self-attention GCN.

FIG. 5A shows an exemplary image with joint pose estimation and normalization.

FIG. 5B shows an exemplary image with a plurality of joints.

FIG. 5C shows a flow diagram of embodiments for normalizing a plurality of joint poses to obtained a plurality of normalized joint poses.

FIG. 6A shows a schematic diagram of a feature extractor.

FIG. 6B shows an exemplary diagram of a feature extractor.

FIG. 7A shows a schematic diagram of a feature dimension reducer.

FIG. 7B shows a flow diagram of embodiments for reducing a feature dimension of a plurality of rough features to obtain a plurality of dimension-shrunk features.

FIG. 8A shows a schematic diagram of a feature refiner including a transformer encoder-like self-attention layer.

FIG. 8B shows an exemplary diagram of a feature refiner including a transformer encoder-like self-attention layer.

FIG. 9A shows a schematic diagram of a classifier including a fully connected layer and a softmax layer.

FIG. 9B shows a flow diagram of embodiments for recognizing a human action based on a plurality of refined features.

FIG. 9C shows an exemplary image for display based on a human action predicated by an actional-structural self-attention GCN.

FIG. 9D shows another exemplary image for display based on a human action predicated by an actional-structural self-attention GCN.

FIG. 10A shows a chart for the top-1 accuracy metric on five evaluation epochs for a ST-GCN and an actional-structural self-attention GCN system.

FIG. 10B shows a chart for the top-5 accuracy metric on five evaluation epochs for the ST-GCN and the actional-structural self-attention GCN system used in FIG. 10A.

FIG. 11 shows an exemplary application of the embodiments in the present disclosure, showing seniors are doing exercise in an elderly care center.

### DETAILED DESCRIPTION

The method will now be described with reference to the accompanying drawings, which show, by way of illustration, specific exemplary embodiments. The method may, however, be embodied in a variety of different forms and, therefore, covered or claimed subject matter is intended to be construed as not being limited to any exemplary embodiments set forth. The method may be embodied as methods, devices, components, or systems. Accordingly, embodiments may, for example, take the form of hardware, software, firmware or any combination thereof.

Throughout the specification and claims, terms may have nuanced meanings suggested or implied in context beyond an explicitly stated meaning. Likewise, the phrase “in one embodiment” or “in some embodiments” as used herein does not necessarily refer to the same embodiment and the phrase “in another embodiment” or “in other embodiments” as used herein does not necessarily refer to a different embodiment. The phrase “in one implementation” or “in some implementations” as used herein does not necessarily refer to the same implementation and the phrase “in another implementation” or “in other implementations” as used herein does not necessarily refer to a different implementation. It is intended, for example, that claimed subject matter includes combinations of exemplary embodiments or implementations in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” or “at least one” as used herein, depending at least in part upon context, may be used to describe any feature, structure, or characteristic in a singular sense or may be used to describe combinations of features, structures or characteristics in a plural sense. Similarly, terms, such as “a”, “an”, or “the”, again, may be understood to convey a singular usage or to convey a plural usage, depending at least in part upon context. In addition, the term “based on” or “determined by” may be understood as not necessarily intended to convey an exclusive set of factors and may, instead, allow for existence of additional factors not necessarily expressly described, again, depending at least in part on context.

The present disclosure describes methods, devices, systems, and storage medium for recognizing one or more human action using a modified spatial-temporal graph convolutional network (GCN) with a self-attention model.

Dynamics of human body skeletons may convey significant information for recognizing various human actions. For example, there may be scenarios, for example but not limited to, modeling dynamics of human body skeletons based on one or more video clip, and recognizing various human activities based on the dynamics of human body skeletons. The human activities may include, but not limited to, walking, standing, running, jumping, turning, skiing, playing tai-chi, and the like.

Recognizing various human activities from one or more video clip may play an important role in understanding content of the one or more video clip, and/or monitoring one or more subject's behavior in a certain environment. Recently, machine learning and/or artificial intelligence (AI) was applied in recognizing human activities. A big challenge remained for a machine to understand the meaning accurately and efficiently on real time high-definition (HD) video.

Neural networks is one of the most popular machine learning algorithms, and achieved some success in accuracy and speed. Neural network includes various variants, for example but not limited to, convolutional neural networks (CNN), recurrent neural networks (RNN), auto-encoders, and deep learning.

Dynamics of human body skeletons may be represented by a skeleton sequence or a plurality of joint poses, which may be represented by two-dimensional or three-dimensional coordinates of more than one human joints in more than one frames. Each frame may represent the coordinates of joint poses at a different time point, for example, a sequential time point during a time lapse of a video clip. It was a challenge to let computer get the meaning from image frames in videos. For example, a video clip of gymnastic competition, judges may watch a gymnast competing in the competition for further evaluation and/or assessment; and it was challenge to have a computer to achieve a comparable efficiency, accuracy, and reliability.

A model of dynamic skeletons called spatial-temporal graph convolutional networks (ST-GCN), which automatically learn both the spatial and temporal patterns from data. This formulation not only leads to greater expressive power but also stronger generalization capability.

For a standard ST-GCN model, pose estimation may be performed on videos and construct spatial temporal graph on skeleton sequences. Multiple layers of spatial-temporal graph convolutional network (ST-GCN) generate higher-level feature maps on the graph, which may then be classified to the corresponding action category. The ST-GCN model may work on action recognition with high accuracy, and its speed may be limited to relatively low frame rate even with a relatively powerful computer, for example, around 10 frame per second (FPS) with a computer equipped with a GTX-1080Ti graphic processing unit (GPU). This may hinder its real-time applications, which may require about or more than 25 FPS.

It may be desired to design a simplified ST-GCN which can reach higher speed (for example, reaching about or more than 25 FPS) without scarifying the accuracy of action recognition. The present disclosure describes various embodiments for recognizing a human action using the simplified ST-GCN without scarifying the accuracy of action recognition, addressing some of the issues discussed above. The various embodiment may include an actional-structural self-attention GCN for recognizing one or more action.

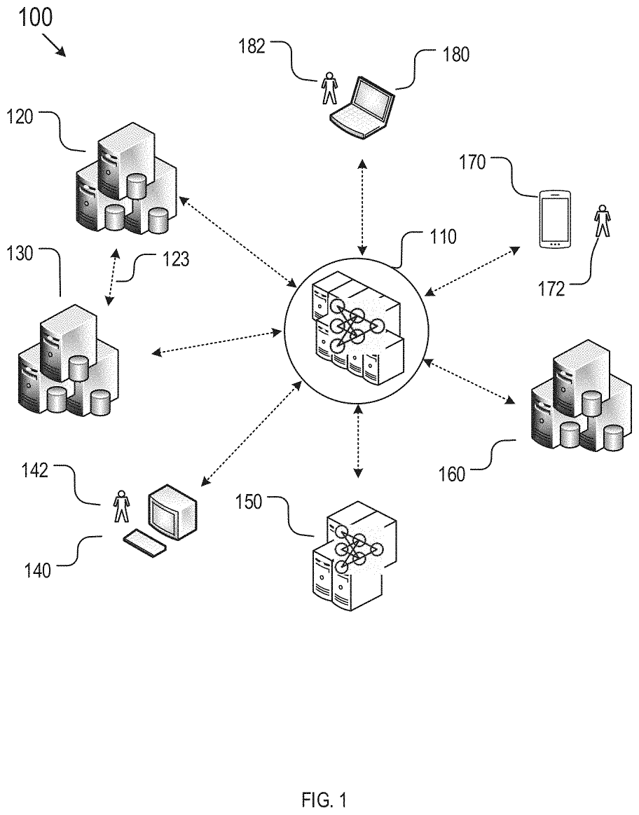

FIG. 1 shows an exemplary electronic communication environment 100 in which an actional-structural self-attention GCN system may be implemented. The electronic communication environment 100 may include the actional-structural self-attention GCN system 110. In other implementation, the actional-structural self-attention GCN system 110 may be implemented as a central server or a plurality of servers distributed in the communication networks.

The electronic communication environment 100 may also include a portion or all of the following: one or more databases 120, one or more two-dimension image/video acquisition servers 130, one or more user devices (or terminals, 140, 170, and 180) associated with one or more users (142, 172, and 182), one or more application servers 150, one or more three-dimension image/video acquisition servers 160.

Any one of the above components may be in direct communication with each other via public or private communication networks (for example, local-network or Internet), or may be in indirect communication with each other via a third party. For example but not limited to, the database 120 may communicate with the two-dimension image/video acquisition server 130 (or the three-dimension image/video acquisition server 160) without via the actional-structural self-attention GCN system 110, for example, the acquired two-dimension video may be sent directly via 123 from the two-dimension image/video acquisition server 130 to the database 120, so that the database 120 may store the acquired two-dimension video in its database.

In one implementation, referring to FIG. 1, the actional-structural self-attention GCN system may be implemented on different servers from the database, two-dimension image/video acquisition server, three-dimension image/video acquisition server, or application server. In other implementations, the actional-structural self-attention GCN system, one or more databases, one or more two-dimension image/video acquisition servers, one or more three-dimension image/video acquisition servers, and/or one or more application servers may be implemented or installed on a single computer system, or one server comprising multiple computer systems, or multiple distributed servers comprising multiple computer systems, or one or more cloud-based servers or computer systems.

The user devices/terminals (140, 170, and 180) may be any form of mobile or fixed electronic devices including but not limited to desktop personal computer, laptop computers, tablets, mobile phones, personal digital assistants, and the like. The user devices/terminals may be installed with a user interface for accessing the actional-structural self-attention GCN system.

The database may be hosted in a central database server, a plurality of distributed database servers, or in cloud-based database hosts. The database 120 may be configured to store image/video data of one or more subject performing certain actions, the intermediate data, and/or final results for implementing the actional-structural self-attention GCN system.

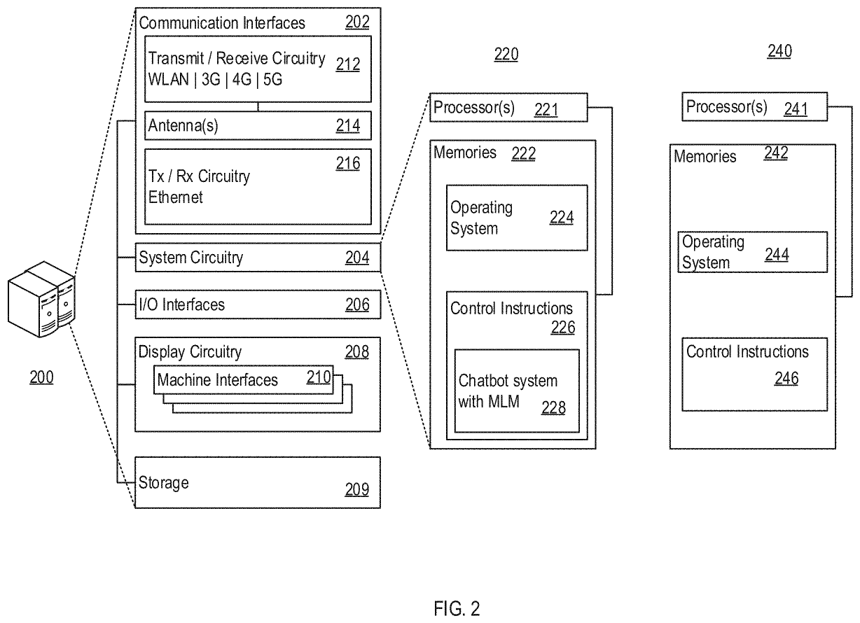

FIG. 2 shows an exemplary device, for example, a computer system 200, for implementing the actional-structural self-attention GCN system 110, the application server 150, or the user devices (140, 170, and 180). The computer system 200 may include communication interfaces 202, system circuitry 204, input/output (I/O) interfaces 206, storage 209, and display circuitry 208 that generates machine interfaces 210 locally or for remote display, e.g., in a web browser running on a local or remote machine. The machine interfaces 210 and the I/O interfaces 206 may include GUIs, touch sensitive displays, voice inputs, buttons, switches, speakers and other user interface elements. Additional examples of the I/O interfaces 206 include microphones, video and still image cameras, headset and microphone input/output jacks, Universal Serial Bus (USB) connectors, memory card slots, and other types of inputs. The I/O interfaces 206 may further include keyboard and mouse interfaces.

The communication interfaces 202 may include wireless transmitters and receivers (“transceivers”) 212 and any antennas 214 used by the transmitting and receiving circuitry of the transceivers 212. The transceivers 212 and antennas 214 may support Wi-Fi network communications, for instance, under any version of IEEE 802.11, e.g., 802.11n or 802.11ac. The transceivers 212 and antennas 214 may support mobile network communications, for example, 3G, 4G, and 5G communications. The communication interfaces 202 may also include wireline transceivers 216, for example, Ethernet communications.

The storage 209 may be used to store various initial, intermediate, or final data or model for implementing the actional-structural self-attention GCN system. These data corpus may alternatively be stored in the database 120 of FIG. 1. In one implementation, the storage 209 of the computer system 200 may be integral with the database 120 of FIG. 1. The storage 209 may be centralized or distributed, and may be local or remote to the computer system 200. For example, the storage 209 may be hosted remotely by a cloud computing service provider.

The system circuitry 204 may include hardware, software, firmware, or other circuitry in any combination. The system circuitry 204 may be implemented, for example, with one or more systems on a chip (SoC), application specific integrated circuits (ASIC), microprocessors, discrete analog and digital circuits, and other circuitry.

For example, the system circuitry 204 may be implemented as 220 for the actional-structural self-attention GCN system 110 of FIG. 1. The system circuitry 220 of the actional-structural self-attention GCN system may include one or more processors 221 and memories 222. The memories 222 stores, for example, control instructions 226 and an operating system 224. The control instructions 226, for example may include instructions for implementing the components 228 of the actional-structural self-attention GCN system. In one implementation, the instruction processors 221 execute the control instructions 226 and the operating system 224 to carry out any desired functionality related to the actional-structural self-attention GCN system.

Likewise, the system circuitry 204 may be implemented as 240 for the user devices 140, 170, and 180 of FIG. 1. The system circuitry 240 of the user devices may include one or more instruction processors 241 and memories 242. The memories 242 stores, for example, control instructions 246 and an operating system 244. The control instructions 246 for the user devices may include instructions for implementing a communication interface with the actional-structural self-attention GCN system. In one implementation, the instruction processors 241 execute the control instructions 246 and the operating system 244 to carry out any desired functionality related to the user devices.

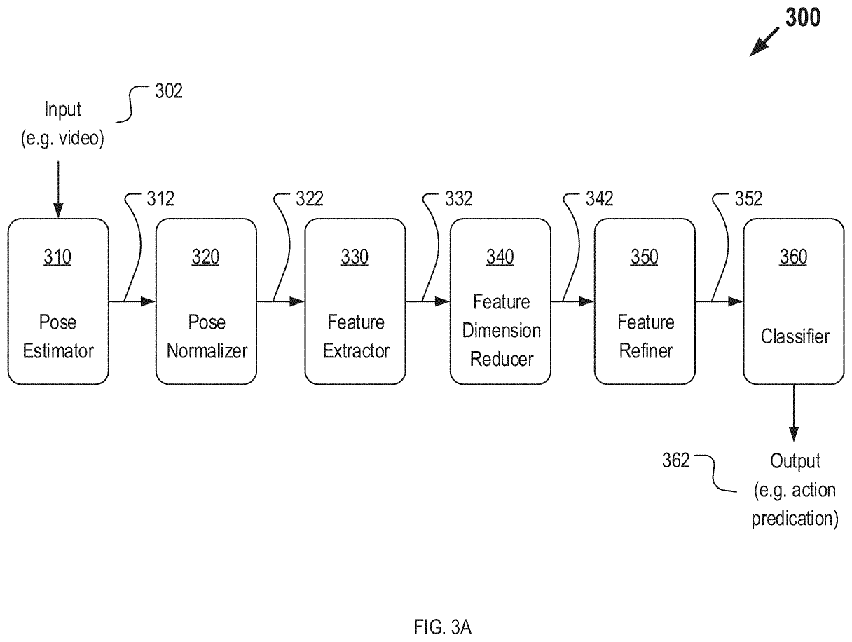

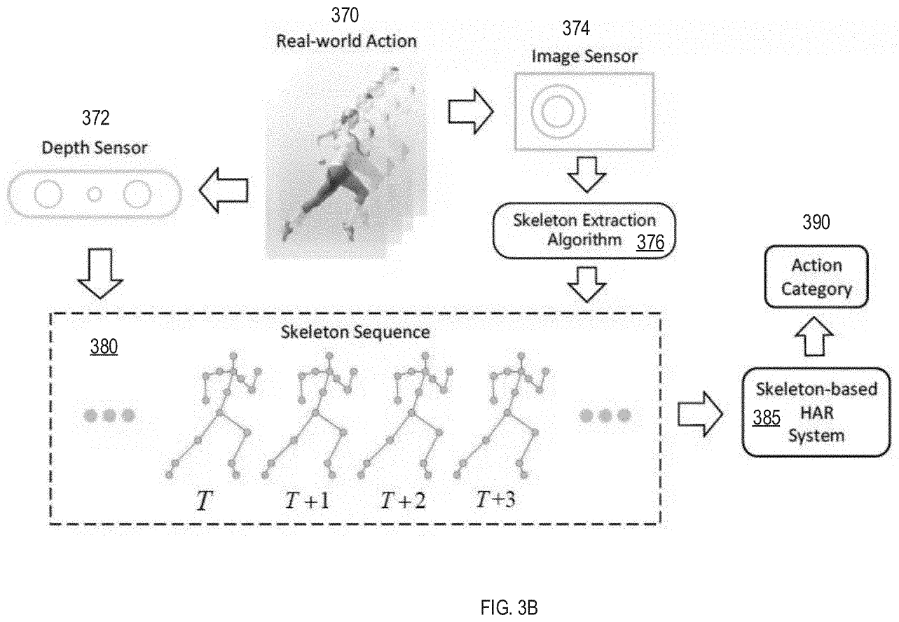

Referring to FIG. 3A, the present disclosure describes embodiments of an actional-structural self-attention graphic convolutional network (GCN) 300 for recognizing a human action based on one or more video clip. The actional-structural self-attention GCN 300 may include a portion or all of the following functional components: a pose estimator 310, a pose normalizer 320, a feature extractor 330, a feature dimension reducer 340, a feature refiner 350, and a classifier 360. One or more of the functional components in the actional-structural self-attention GCN 300 in FIG. 3A may be implemented by one device shown in FIG. 2, or alternatively, the one or more of the functional components in the actional-structural self-attention GCN may be implemented by more than one devices shown in FIG. 2, which communicate between them to coordinately function as the actional-structural self-attention GCN.

The actional-structural self-attention GCN 300 may receive an input 302, and may generate an output 362. The input 302 may include video data, and the output 362 may include one or more action prediction based on the video data. The pose estimator 310 may receive the input 302 and perform pose estimation to obtain and output a plurality of joint poses 312. The pose normalizer 320 may receive the plurality of joint poses 312 and perform pose normalization to obtain and output a plurality of normalized joint poses 322. The feature extractor 330 may receive the plurality of normalized joint poses 322 and perform feature extraction to obtain and output a plurality of rough features 332. The feature dimension reducer 340 may reduce the plurality of rough features 332 and perform feature dimension reduction to obtain and output a plurality of dimension-shrunk features 342. The feature refiner 350 may receive the plurality of dimension-shrunk features 342 and perform feature refinement to obtain and output a plurality of refined features 352. The classifier 360 may receive the plurality of refined features 352 and perform classification and prediction to obtain and output the output 362 including the one or more action predication.

FIG. 3B shows a work flow of skeleton based human action recognition. Skeleton graph networks shows significant advantages on action recognition over previous conventional methods, for example but not limited to, the skeleton based action recognition methods may avoid variation due to background and/or body texture interference. A real-world action 370 (e.g., running) may be captured by a depth sensor 372 and/or an image sensor 374. The acquired image data from the image sensor may be process by skeleton extraction algorithm 376. The extracted skeleton data and/or the depth sensor data may be used to generate a skeleton sequence 380 in a time lapse fashion. The skeleton sequence may be processed by a skeleton-based human action recognition (HAR) system 385 to obtain an action category 390 as the prediction for the real-world action 370.

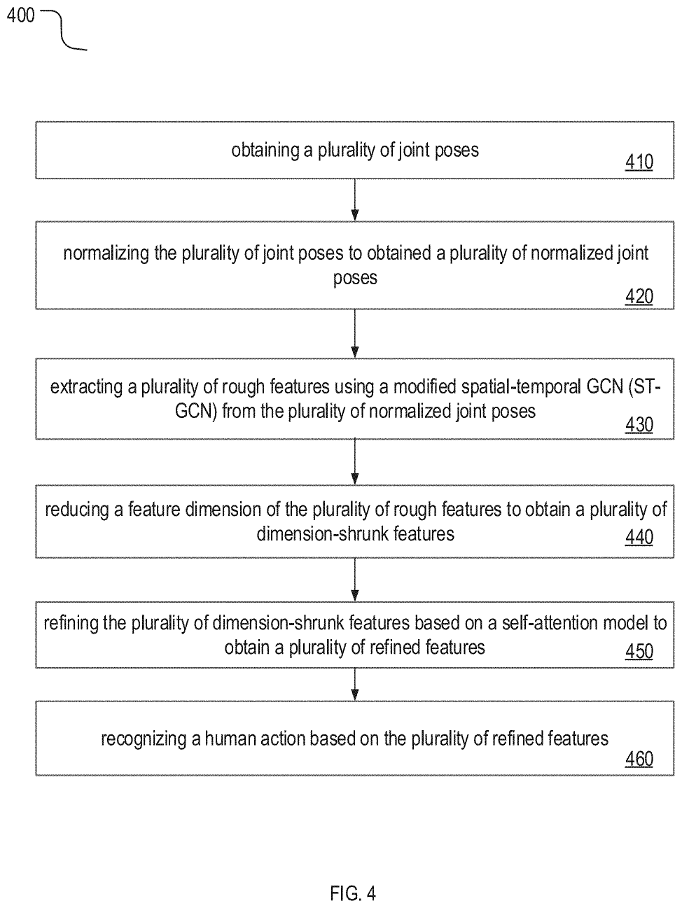

The present disclosure also describes embodiments of a method 400 in FIG. 4 for recognizing a human action using a graph convolutional network, for example an actional-structural self-attention graphic convolutional network. The method 400 may be implemented by one or more electronic device shown in FIG. 2. The method 400 may include a portion or all of the following steps: step 410: obtaining a plurality of joint poses; step 420: normalizing the plurality of joint poses to obtained a plurality of normalized joint poses; step 430: extracting a plurality of rough features using a modified spatial-temporal GCN (ST-GCN) from the plurality of normalized joint poses; step 440: reducing a feature dimension of the plurality of rough features to obtain a plurality of dimension-shrunk features; step 450: refining the plurality of dimension-shrunk features based on a self-attention model to obtain a plurality of refined features; and step 460: recognizing a human action based on the plurality of refined features.

Referring to the step 410, obtaining a plurality of joint poses may be performed by a pose estimator 310 in FIG. 3A. The pose estimator may receive an input including video data. The video data may include a number of frames over a period of time. The pose estimator 310 may process the video data to obtain and output a plurality of joint poses 312 based on one or more pose estimation algorithms. The pose estimator 310 may utilize one or more hand-crafted feature based method and/or one or more deep learning method to generate a plurality of joint poses based on the video data. In one implementation, the video data may include data acquired based on depth sensor, so a three-dimension coordinates for the more than one joints may be obtained.

In one implementation, the plurality of joint poses may be obtained from one or more motion-capture image sensor, for example but not limited to, depth sensor, camera, video recorder, and the like. In some other implementations, the plurality of joint poses may be obtained from videos according to pose estimation algorithms. The output from the motion-capture devices or the videos may include a sequence of frames. Each frame may corresponding to a particular time points in sequence, and each frame may be used to generate joint coordinates, forming the plurality of joint poses.

In one implementation, the plurality of joint poses may include joint coordinates in a form of two-dimension coordinates, for example (x, y) where x is the coordinate along x-axis and y is the coordinate along y-axis. A confidence score for each joint may be added into the two-dimension coordinates, so that each joint may be represented with a tuple of (x, y, c) wherein c is the confidence score for this joint's coordinates.

In another implementation, the plurality of joint poses may include joint coordinates in a form of three-dimension coordinates, for example (x, y, z) where x is the coordinate along x-axis, y is the coordinate along y-axis, and z is the coordinate along z-axis. A confidence score for each joint may be added into the three-dimension coordinates, so that each joint may be represented with a tuple of (x, y, z, c) wherein c is the confidence score for this joint's coordinates.

Referring to step 420, normalizing the plurality of joint poses to obtained a plurality of normalized joint poses may be performed by a pose normalizer 320 in FIG. 3A.

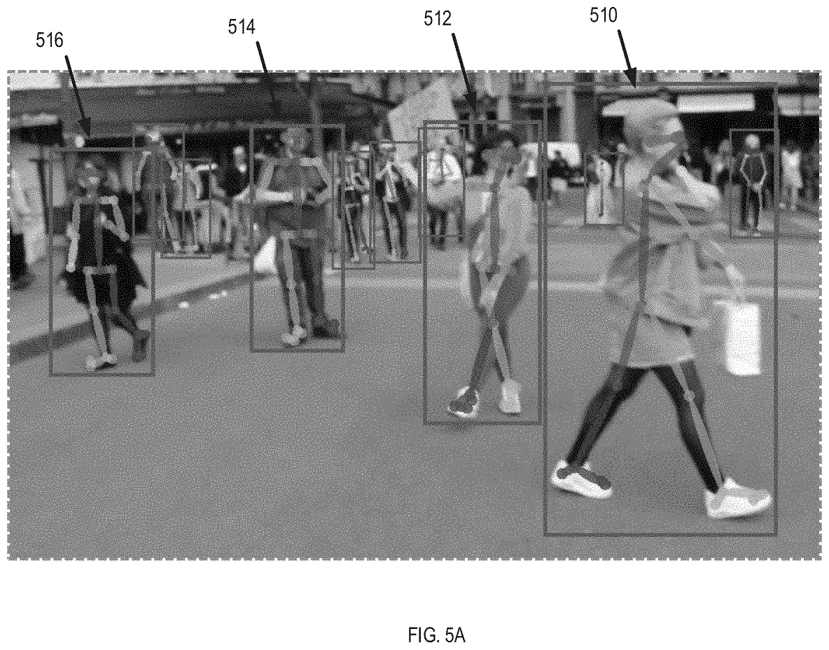

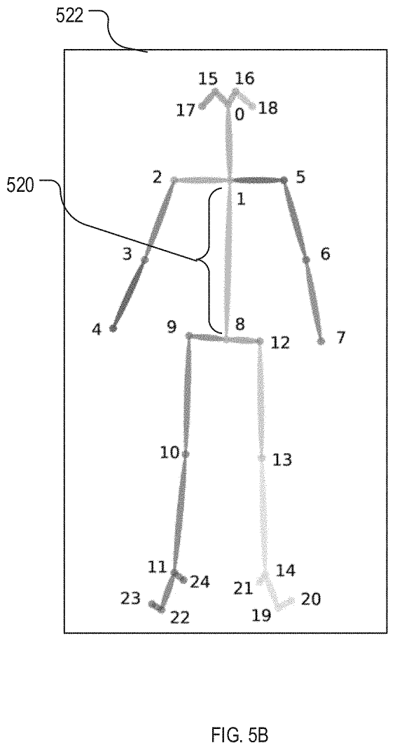

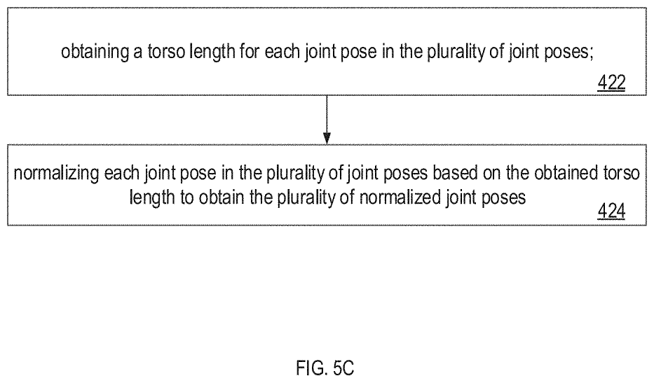

FIG. 5A shows one example of an image frame in a video clip with one or more sets of joint coordinates for one or more subject (510, 512, 514, 516, and others) in the image frame. For each subject, a number of joints may be recognized and their coordinates are obtained. The number of joints may be any positive integer, for example but not limited to, 10, 18, 20, 25, and 32. A relative bounding box may be drawn to enclose a subject.

FIG. 5B shows one example of 25 joints (from Joint No. 0 to Joint No. 24) for one subject. For each subject, a torso length may be obtained. The torso length may be a distance 520 between Joint No. 1 and Joint No. 8. Joint No. 8 may be used as a center of the bounding box 522 for enclosing the subject.

Referring to FIG. 5C, the step 420 may include a portion or all of the following steps: step 422: obtaining a torso length for each joint pose in the plurality of joint poses; step 424: normalizing each joint pose in the plurality of joint poses based on the obtained torso length to obtain the plurality of normalized joint poses.

The step 420 may include fixed torso length normalization, wherein all pose coordinates may be normalized relative to the torso length. Optionally and alternatively, if a torso length for one subject is not detected for this image frame, the method may discard this subject and do not analysis the pose coordinates for this subject for this image frame, for example, when at least one of the Joint No. 1 and Joint No. 8 for this subject is not in the image frame or not visible due to being block by another subject or object.

Referring to step 430, extracting a plurality of rough features using a modified spatial-temporal GCN (ST-GCN) from the plurality of normalized joint poses may be performed by a feature extractor 330. The feature extractor may include a modified spatial-temporal GCN (ST-GCN).

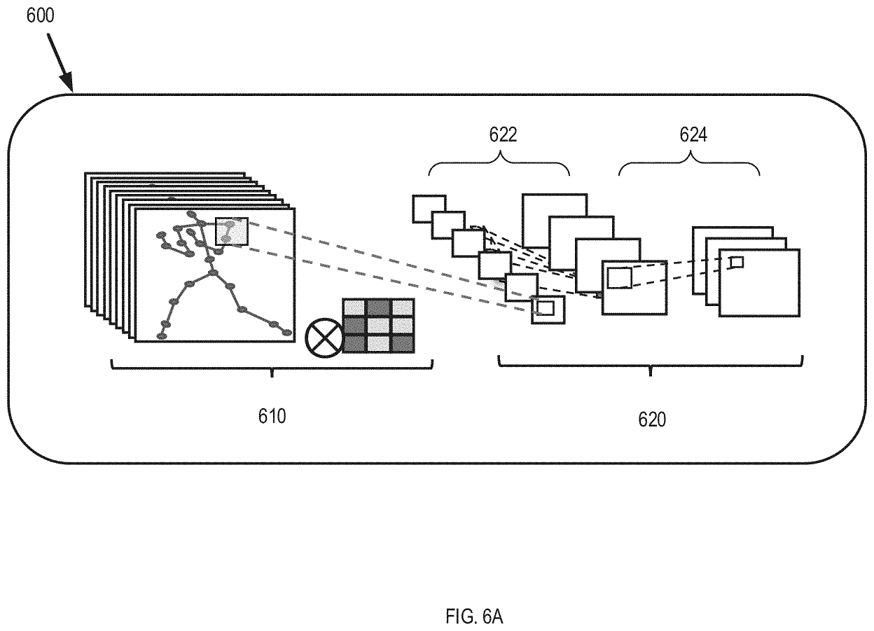

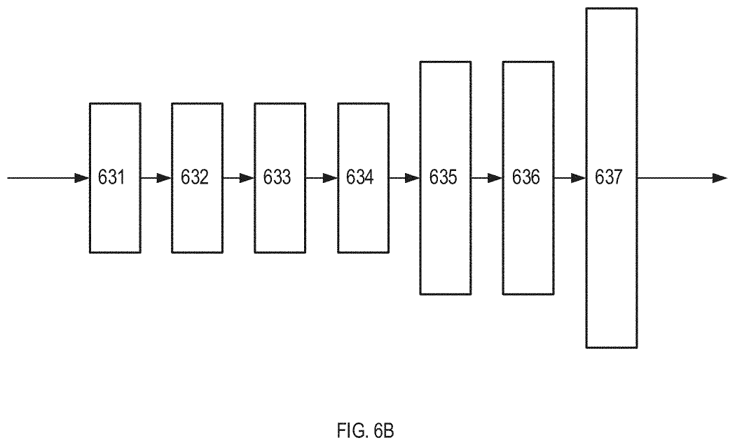

FIG. 6A shows a feature extractor 600 including one or more GCN block. The feature extractor may include two functional units (610 and 620). The first functional unit 610 may include graph network for skeleton data; and the second functional unit 620 may include one or more convolution layer.

In one implementation referring to FIG. 6A, each ST-GCN block may include at least one of a convolution layer 622, and a pooling layer 624. In another implementation, each GCN block may include a nonlinear layer between a convolution layer 622 and a pooling layer 624. The nonlinear layer may include at least one of the following: batch normalization, rectified-linear unit layer, and/or a nonlinear activation function layer (e.g., a sigmoid function).

Each ST-GCN block contains a spatial graph convolution followed by a temporal graph convolution, which alternatingly extracts spatial and temporal features. The spatial graph convolution is a key component in the ST-GCN block, the spatial graph convolution introduces a weighted average of neighboring features for each joint. The ST-GCN block may have a main advantage of extraction of spatial features, and/or may have disadvantage that it may use only a weight matrix to measure inter-frame attention (correlation), which is relatively ineffective.

The number of ST-GCN blocks in a feature extractor model may be, for example but not limited to, 3, 5, 7, 10, or 13. The more ST-GCN blocks the feature extractor includes, the more number of total parameters in the model, and the more complexity of the calculation and the longer of the computing time required to complete the calculation. A ST-GCN including 10 ST-GCN blocks may be slower than a ST-GCN including 7 ST-GCN blocks due to the larger number of total parameters. For example, a standard ST-GCN may include 10 ST-GCN blocks, and parameters for each corresponding ST-GCN blocks may include 3×64(1), 64×64(1), 64×64(1), 64×64(1), 64×128(2), 128×128(1), 128×128(1), 128×256(2), 256×256(1), and 256×256(1). A standard ST-GCN including 10 ST-GCN blocks may include a number of total parameters being 3,098,832.

For one exemplary embodiment referring to FIG. 6B, a feature extractor may include a light-weighted ST-GCN model that includes 7 ST-GCN blocks (631, 632, 633, 634, 635, 636, and 637), and parameters for each corresponding ST-GCN blocks may include 3×32(1), 32×32(1), 32×32(1), 32×32(1), 32×64(2), 64×64(1), and 64×128(1). The light-weighted ST-GCN model including 7 ST-GCN blocks may include a number of total parameters being 2,480,359, which is about 20% reduction compared to a standard ST-GCN including 10 ST-GCN blocks. The light-weighted ST-GCN model including 7 ST-GCN blocks may run much faster than the standard ST-GCN including 10 ST-GCN blocks.

The feature extractor may include, based on the plurality of normalized joint poses, to construct a spatial-temporal graph with the joints as graph nodes and natural connectivities in both human body structures and time as graph edges.

For one example in one implementation, an undirected spatial temporal graph G=(V, E) may be constructed based on the plurality of normalized joint poses.

V may be the node set including N joints and T frames, for example V includes vₜᵢ, wherein t is a positive integer representing the frame No. from 1 to T, inclusive; and i is a positive integer representing the Joint No. from 1 to N, inclusive.

E may be the edge set including two edge subsets. The first edge subset may represent an intra-skeleton connection at each frame, for example, the first edge subset E_{f} includes vₜᵢ*vₜⱼ, wherein t is a positive integer representing the frame No. from 1 to T, inclusive; i is a positive integer representing the first Joint No. of the intra-skeleton connection from 1 to N, inclusive; and j is a positive integer representing the second Joint No. of the intra-skeleton connection from 1 to N, inclusive.

The second edge subset may represent the inter-frame edges connecting the same joint in consecutive frames, for example, the second edge subset Eₛ includes vₜᵢ*v₍ₜ₊₁₎ᵢ, wherein t is a positive integer representing the frame No. from 1 to T, inclusive; t+1 is the consecutive frame; and i is a positive integer representing the first Joint No. of the intra-skeleton connection from 1 to N, inclusive.

Referring to step 440, reducing a feature dimension of the plurality of rough features to obtain a plurality of dimension-shrunk features may be performed by a feature dimension reducer. The step 440 may add convolution on joints to get key joints and reduce feature dimensions for further processing.

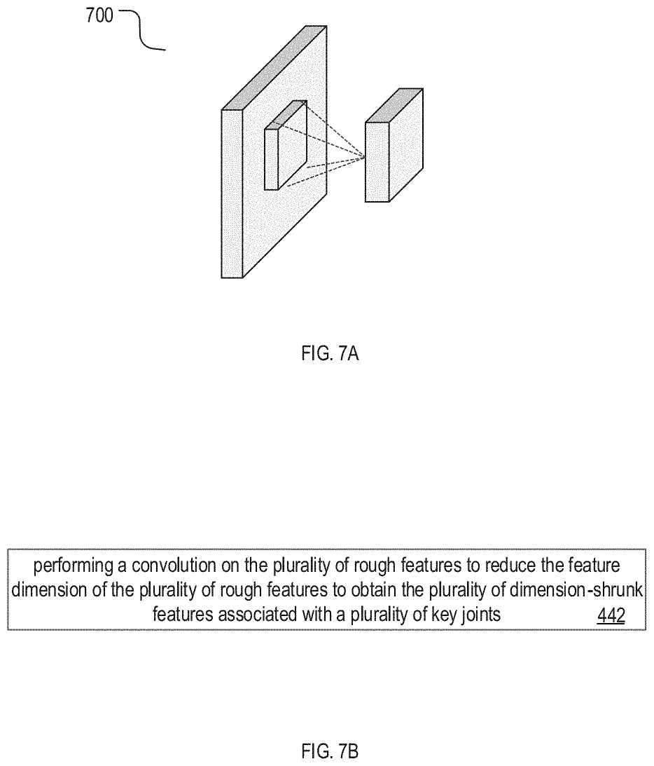

As shown in FIG. 7A, a feature dimension reducer 700 may reduce a number of joints, for example but not limited to, the number of joints is reduced from 25 to 12, which corresponds to about 52% reduction (calculated by 13 divided by 25).

In one implementation, the sequence length output from the feature extractor is 75×25×256, and the feature dimension reducer may reduce the sequence length to 18×12×128, wherein 18×12=216 is the length of sequence, and 128 is the vector dimension.

Referring to FIG. 7B, the step 440 may include the following step: step 442: performing a convolution on the plurality of rough features to reduce the feature dimension of the plurality of rough features to obtain the plurality of dimension-shrunk features associated with a plurality of key joints.

Referring to step 450, refining the plurality of dimension-shrunk features based on a self-attention model to obtain a plurality of refined features may be performed by a feature refiner 350 in FIG. 3A. The step 450 may refine the features with self-attention scheme between key frames.

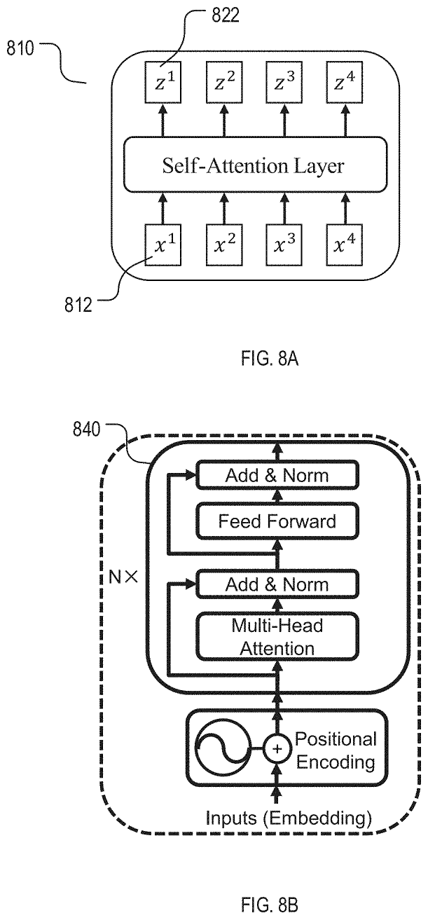

Referring to FIG. 8A, a feature refiner may include a transformer encoder-like self-attention model 810 including a self-attention layer to extract refined feature. Transformer encoder may include one or more multi-head attention layer, one or more position-wise feed-forward layer, one or more residual connection layer, and/or one or more layer normalization. The self-attention layer may include one or more input (e.g, 812) and one or more output (e.g, 822). Transformer models are widely used in sequence-to-sequence tasks of natural language processing (NLP) applications, e.g., translation, summarization, and/or speech recognition. The transformer model may be used to learn inter-frame attention (e.g., correlation) and refine the features in computer vision (CV) based action recognition.

Referring to FIG. 8B, a transformer encoder-like self-attention model may include one or more module 840. In one implementation, the transformer encoder-like self-attention model may include (N×) modules 840, wherein a subsequent module may be stacked on top of the previous module. Each module 840 may include a multi-head attention layer and a feed-forward layer. In one implementation, these stacked modules may be executed in parallel for speed optimization. N may be a positive integer, for example but not limited to, 1, 3, 5, 6, 8, and 10. In one implementation, the N may be preferably in a range between 3 and 6, inclusive.

An actional-structural self-attention GCN may use the transformer encoder-like self-attention model, instead of a mere weight matrix, to explicitly learn inter-frame attention (correlation). The transformer encoder-like self-attention mechanism may also serve to refine the features, so that the level of accuracy may be preserved in comparing with the original ST-GCN model. The actional-structural self-attention GCN in the present disclosure may use the transformer encoder-like self-attention model to achieve at least the same level of accuracy as of a standard ST-GCN with at least twice of the action-recognition speed.

Referring to step 460, recognizing a human action based on the plurality of refined features may be performed by a classifier 360 in FIG. 3A. The classifier output one or more human action prediction based on the plurality of refined features.

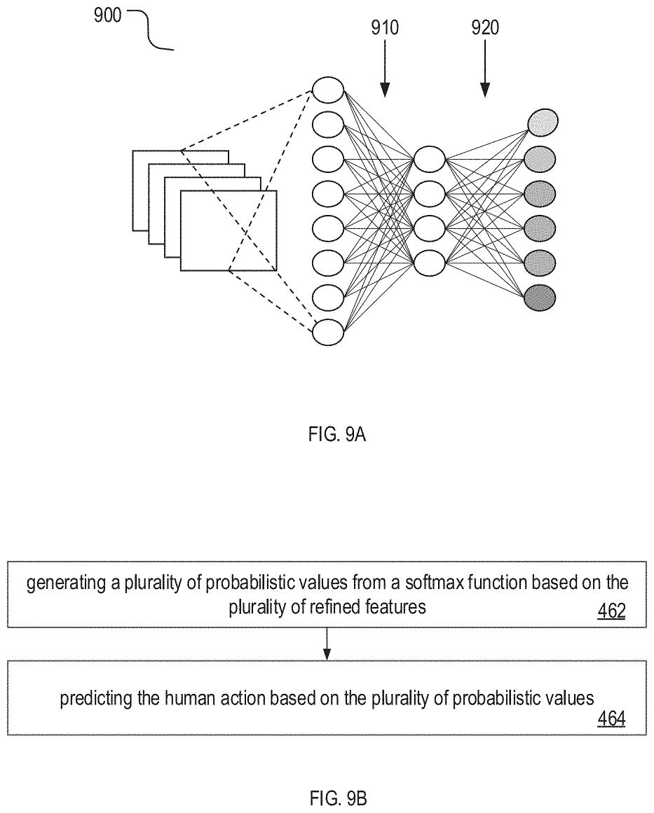

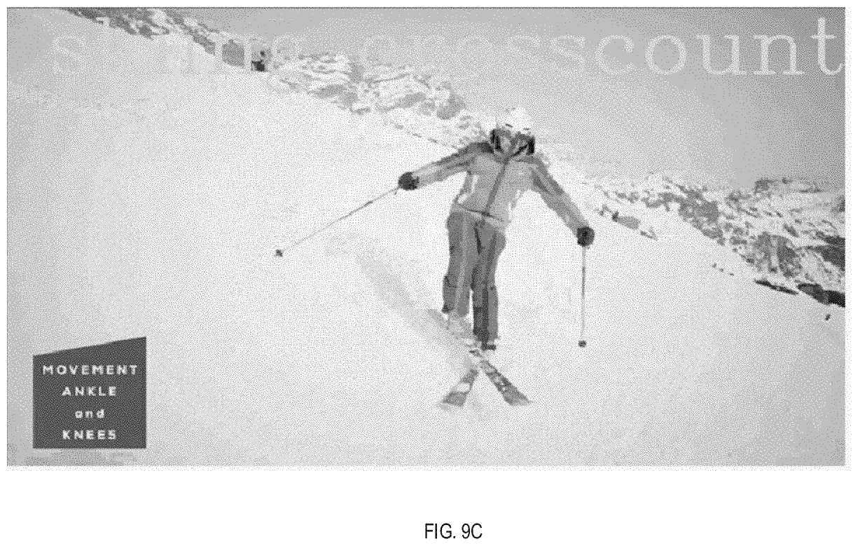

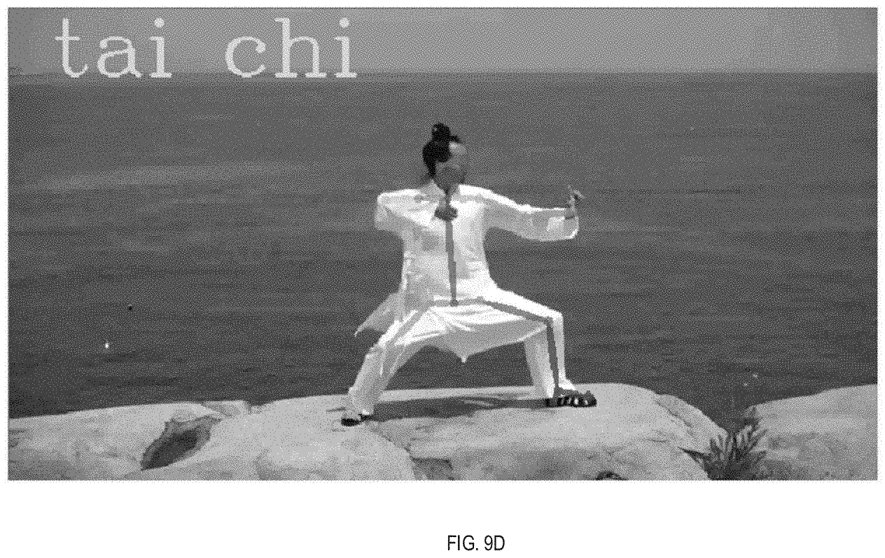

Referring to FIG. 9A, a classifier 900 may include a fully connected layer 910 and a softmax layer 920. The fully connected layer 910 may flatten the input of the classifier into a single vector of values, each representing a probability that a certain feature belongs to a certain category. The softmax layer 920 may transform an unnormalized output from the fully connected layer 910 to a probability distribution which is a normalized output). When a category with the highest probability reaches or is above a preset threshold, the classifier output the category as the predicated human action.

Referring to FIG. 9B, the step 460 may include the following steps: step 462: generating a plurality of probabilistic values from a softmax function based on the plurality of refined features; and step 464: predicting the human action based on the plurality of probabilistic values.

Optionally, the method may further include overlaying the predicated human action on one or more image frame, and displaying the overlaid image frame. In one implementation, the predicated human action may be overlaid as a text with a prominent font type, size, or color. Optionally and/or alternatively in another implementation, the joint pose in the overlaid image frame may be displayed as well.

For example, FIG. 9C is a display for a person with a predicated human action as “skiing crosscounty”. For another example, FIG. 9D is a display for a person with a predicated human action as playing “tai chi”.

The embodiments described in the present disclosure may be trained according to a general ST-GCN and/or tested by using standard reference datasets, for example but not limited to, the action recognition NTU RGB+D Dataset (http://rose1.ntu.edu.sg/datasets/actionrecognition.asp), and the Kinetics Dataset (https://deepmind.com/research/open-source/kinetics).

The NTU-RGB+D Dataset contains 56,880 skeletal motion sequences completed by one or two performers, which are divided into 60 categories (i.e, 60 human action classes). The NTU-RGB+D Dataset is one of the largest data sets for skeleton-based action recognition. The NTU-RGB+D Dataset provides each person with three-dimension spatial coordinates of 25 joints in one action. To evaluate the model, two protocols may be used: a first protocol of cross-subject, and a second protocol of cross-view. In the “cross-theme”, 40 samples executed by 20 objects, 320 samples may be divided into training sets, and the rest belong to the test set. Cross-View may allocate data based on camera views, where the training and test sets may include 37,920 and 18,960 samples, respectively.

The Kinetics Dataset is a large dataset for human behavior analysis, containing more than 240,000 video clips with 400 actions. Since only red-green-blue (RGB) video is provided, the OpenPose toolbox may be used to obtain skeleton data by estimating joint positions on certain pixels. The toolbox will generate two-dimension pixel coordinates (x, y) and confidence c for a total of 25 joints from the resized video with a resolution of 340 pixels×256 pixels. Each joint may be represented as a three-element feature vector: [x, y, c]. For the multi-frame case, the body with the highest average joint confidence in each sequence may be chosen. Therefore, a clip with T frames is converted into a skeleton sequence with a size of 25×3×T.

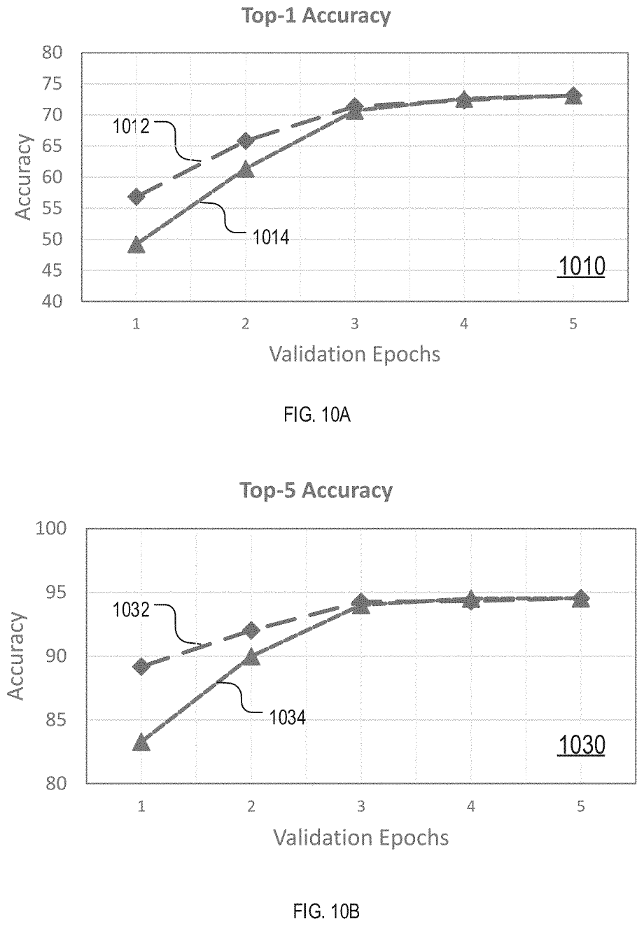

FIGS. 10A and 10B show some experimental results on five evaluation epochs of two comparison systems when the NTU-RGB+D Dataset is used. A first system including a standard ST-GCN system with 10 ST-GCN blocks, and a second system being an actional-structural self-attention GCN system with 7 ST-GCN blocks.

Chart 1010 in FIG. 10A shows the top-1 accuracy metric on five evaluation epochs for the ST-GCN 1014 and the actional-structural self-attention GCN system 1012. Apparently, during the first two epochs, the actional-structural self-attention GCN system 1012 has a much higher accuracy than the ST-GCN 1014; and during the third to five epochs, the actional-structural self-attention GCN system 1012 has about same or better accuracy than the ST-GCN 1014.

Chart 1030 in FIG. 10B shows the top-5 accuracy metric on five evaluation epochs for the ST-GCN 1034 and the actional-structural self-attention GCN system 1032. Apparently, during the first two epochs, the actional-structural self-attention GCN system 1032 has a much higher accuracy than the ST-GCN 1034; and during the third to five epochs, the actional-structural self-attention GCN system 1032 has about same or better accuracy than the ST-GCN 1034.

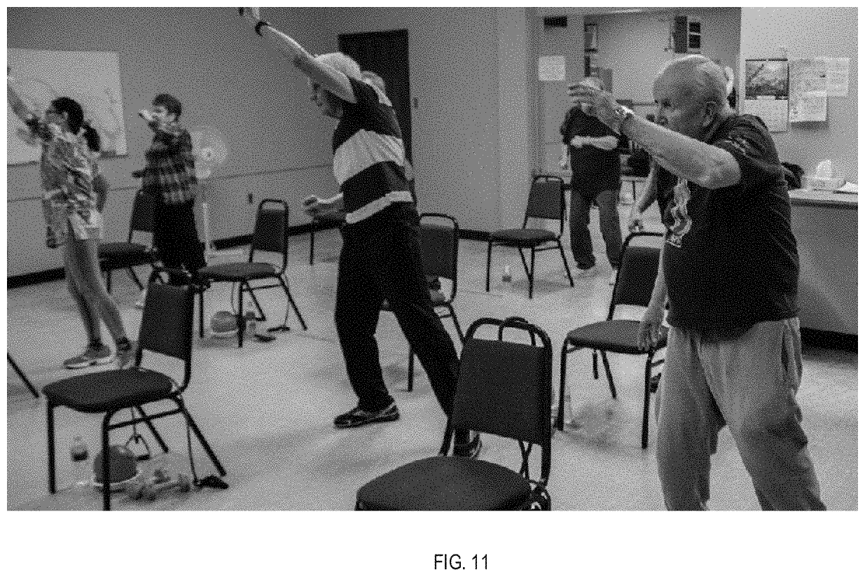

The present disclosure also describes various applications for the embodiments describes above. For one example of the various applications, the embodiments in the present disclosure may be used in an elderly care center. With the help of action recognition technology provided by the embodiments in the present disclosure, service personnel at the elderly care center may more accurately record main activities of a group of the elderly, and then analyse these data to improve the lives of seniors, for example, during seniors doing exercise in an elderly care center (see FIG. 11). In addition, with the help of action recognition technology, the number of centre service staff required to provide care can be further reduced, and at the same time, possible injurious behaviours of seniors, such as falling down could be more accurately and/or promptly detected.

For another example of the various applications, the embodiments in the present disclosure may be used in auto detection. On some occasions, people may need to carry out a lot of repetitive tasks, for example, car manufacturing plant workers may need to conduct multiple factory inspections on the cars that are about to leave the factory. Such work may often require a high degree of conscientiousness and professional work ethics. If workers fail to perform such duties, it may be difficult to detect this. With action recognition technology, car manufacturing plant personnel may better assess the performance of such staff. The embodiments in the present disclosure may be used to detect whether the main work steps are fully finished by the staff, which may help to ensure staff members to carry out all their required duties to ensure that products are properly tested, and quality assured.

For another example of the various applications, the embodiments in the present disclosure may be used in smart schools. The embodiments in the present disclosure may be installed in public places like primary and secondary school campuses, to help school administrators identify and address certain problems that may exist with a few primary and secondary school students. For example, there may be incidents of campus bullying and school fights in some elementary and middle schools. Such incidents may occur when teachers are not present or may occur in a secluded corner of the campus. If these matters are not identified and dealt with in good time, they may escalate, and it may also be difficult to trace back to the culprits after the event. Action recognition and behavior analysis may immediately alert teachers and/or administrators of such situations so that they can be dealt with in a timely manner.

For another example of the various applications, the embodiments in the present disclosure may be used in intelligent prison and detention. The embodiments in the present disclosure may be used to provide detainees' action analysis, with which can measure the detainee mood status more accurately. The embodiments in the present disclosure may also be used to help prison management to detect suspicious behavior by inmates. The embodiments in the present disclosure may be used in detain rooms and prisons for looking out for fights and suicide attempts, which can modernize the city's correctional facilities and provide intelligent prison and detention.

Through the descriptions of the preceding embodiments, persons skilled in the art may understand that the methods according to the foregoing embodiments may be implemented by hardware only or by software and a necessary universal hardware platform. However, in most cases, using software and a necessary universal hardware platform are preferred. Based on such an understanding, the technical solutions of the present disclosure essentially, or the part contributing to the prior art may be implemented in a form of a software product. The computer software product is stored in a storage medium (such as a ROM/RAM, a magnetic disk, or an optical disc) and includes several instructions for instructing a terminal device (which may be a mobile phone, a computer, a server, a network device, or the like) to perform the methods described in the embodiments of the present disclosure.

While the particular invention has been described with reference to illustrative embodiments, this description is not meant to be limiting. Various modifications of the illustrative embodiments and additional embodiments will be apparent to one of ordinary skill in the art from this description. Those skilled in the art will readily recognize these and various other modifications can be made to the exemplary embodiments, illustrated and described herein, without departing from the spirit and scope of the present invention. It is therefore contemplated that the appended claims will cover any such modifications and alternate embodiments. Certain proportions within the illustrations may be exaggerated, while other proportions may be minimized. Accordingly, the disclosure and the figures are to be regarded as illustrative rather than restrictive.

1. A method for recognizing a human action using a graph convolutional network (GCN), the method comprising:
obtaining, by a device comprising a memory storing instructions and a processor in communication with the memory, a plurality of joint poses;
normalizing, by the device, the plurality of joint poses to obtained a plurality of normalized joint poses;
extracting, by the device, a plurality of rough features using a modified spatial-temporal GCN (ST-GCN) from the plurality of normalized joint poses;
reducing, by the device, a feature dimension of the plurality of rough features to obtain a plurality of dimension-shrunk features;
refining, by the device, the plurality of dimension-shrunk features based on a self-attention model to obtain a plurality of refined features; and
recognizing, by the device, a human action based on the plurality of refined features.

2. The method according to claim 1, wherein the normalizing, by the device, the plurality of joint poses to obtained the plurality of normalized joint poses comprises:
obtaining, by the device, a torso length for each joint pose in the plurality of joint poses; and
normalizing, by the device, each joint pose in the plurality of joint poses based on the obtained torso length to obtain the plurality of normalized joint poses.

3. The method according to claim 1, wherein:
the modified ST-GCN comprises fewer ST-GCN blocks than a standard ST-GCN.

4. The method according to claim 3, wherein:
the modified ST-GCN comprises seven ST-GCN blocks.

5. The method according to claim 1, wherein the reducing, by the device, a feature dimension of the plurality of rough features to obtain the plurality of dimension-shrunk features comprises:
performing, by the device, a convolution on the plurality of rough features to reduce the feature dimension of the plurality of rough features to obtain the plurality of dimension-shrunk features associated with a plurality of key joints.

6. The method according to claim 5, wherein:
the self-attention model comprises a transformer encoder comprising a predetermined number of multi-head attention layers and feed-forward layers.

7. The method according to claim 1, wherein recognizing, by the device, a human action based on the plurality of refined features comprises:
generating, by the device, a plurality of probabilistic values from a softmax function based on the plurality of refined features; and
predicting, by the device, the human action based on the plurality of probabilistic values.

8. A device for recognizing a human action using a graph convolutional network (GCN), the device comprising:
a memory storing instructions; and
a processor in communication with the memory, wherein, when the processor executes the instructions, the processor is configured to cause the device to:
obtain a plurality of joint poses;
normalize the plurality of joint poses to obtained a plurality of normalized joint poses;
extract a plurality of rough features using a modified spatial-temporal GCN (ST-GCN) from the plurality of normalized joint poses;
reduce a feature dimension of the plurality of rough features to obtain a plurality of dimension-shrunk features;
refine the plurality of dimension-shrunk features based on a self-attention model to obtain a plurality of refined features; and
recognize a human action based on the plurality of refined features.

9. The device according to claim 8, wherein, when the processor is configured to cause the device to normalize the plurality of joint poses to obtained the plurality of normalized joint poses, the processor is configured to cause the device to:
obtain a torso length for each joint pose in the plurality of joint poses; and
normalize each joint pose in the plurality of joint poses based on the obtained torso length to obtain the plurality of normalized joint poses.

10. The device according to claim 8, wherein:
the modified ST-GCN comprises fewer ST-GCN blocks than a standard ST-GCN.

11. The device according to claim 10, wherein:
the modified ST-GCN comprises seven ST-GCN blocks.

12. The device according to claim 8, wherein, when the processor is configured to cause the device to reduce a feature dimension of the plurality of rough features to obtain the plurality of dimension-shrunk features, the processor is configured to cause the device to:
perform a convolution on the plurality of rough features to reduce the feature dimension of the plurality of rough features to obtain the plurality of dimension-shrunk features associated with a plurality of key joints.

13. The device according to claim 12, wherein:
the self-attention model comprises a transformer encoder comprising a predetermined number of multi-head attention layers and feed-forward layers.

14. The device according to claim 8, wherein, when the processor is configured to cause the device to recognize a human action based on the plurality of refined features, the processor is configured to cause the device to:
generate a plurality of probabilistic values from a softmax function based on the plurality of refined features; and
predict the human action based on the plurality of probabilistic values.

15. A non-transitory computer readable storage medium storing instructions, wherein the instructions, when executed by a processor, cause the processor to perform:
obtaining a plurality of joint poses;
normalizing the plurality of joint poses to obtained a plurality of normalized joint poses;
extracting a plurality of rough features using a modified spatial-temporal GCN (ST-GCN) from the plurality of normalized joint poses;
reducing a feature dimension of the plurality of rough features to obtain a plurality of dimension-shrunk features;
refining the plurality of dimension-shrunk features based on a self-attention model to obtain a plurality of refined features; and
recognizing a human action based on the plurality of refined features.

16. The non-transitory computer readable storage medium according to claim 15, wherein, when the instructions cause the processor to perform normalizing the plurality of joint poses to obtained the plurality of normalized joint poses, the instructions cause the processor to perform:
obtaining a torso length for each joint pose in the plurality of joint poses; and
normalizing each joint pose in the plurality of joint poses based on the obtained torso length to obtain the plurality of normalized joint poses.

17. The non-transitory computer readable storage medium according to claim 15, wherein:
the modified ST-GCN comprises seven ST-GCN blocks.

18. The non-transitory computer readable storage medium according to claim 15, wherein, when the instructions cause the processor to perform reducing a feature dimension of the plurality of rough features to obtain the plurality of dimension-shrunk features, the instructions cause the processor to perform:
performing a convolution on the plurality of rough features to reduce the feature dimension of the plurality of rough features to obtain the plurality of dimension-shrunk features associated with a plurality of key joints.

19. The non-transitory computer readable storage medium according to claim 18, wherein:
the self-attention model comprises a transformer encoder comprising a predetermined number of multi-head attention layers and feed-forward layers.

20. The non-transitory computer readable storage medium according to claim 15, wherein, when the instructions cause the processor to perform recognizing a human action based on the plurality of refined features, the instructions cause the processor to perform:
generating a plurality of probabilistic values from a softmax function based on the plurality of refined features; and
predicting the human action based on the plurality of probabilistic values.
